(19) United States
(12) Patent Application Publication
(10) Pub. No.: US 2026/0117343 A1
(43) Pub. Date: Apr. 30, 2026

(54) ACCELERATOR LEAD-OUT WINDOW AND PREPARATION METHOD THEREOF

(71) Applicant: XI'AN JUNENG MEDICAL ENGINEERING TECHNOLOGY CO., LTD, Xi'an (CN)

(72) Inventors: Dayou WANG, Xi'an (CN); Xiaoyan SHI, Xi'an (CN); Guo YAN, Xi'an (CN); Qinggong JIA, Xi'an (CN); Pingxiang ZHANG, Xi'an (CN)

(73) Assignee: XI'AN JUNENG MEDICAL ENGINEERING TECHNOLOGY CO., LTD, Xi'an (CN)

(21) Appl. No.: 19/365,353

(22) Filed: Oct. 22, 2025

(30) Foreign Application Priority Data
Oct. 25, 2024 (CN) 202411498229.2

(51) Int. Cl. C22C 14/00; B22F 10/28; B23K 26/342; B23K 103/14; B33Y 10/00; B33Y 70/00; B33Y 80/00

(52) U.S. Cl. CPC C22C 14/00; B22F 10/28; B23K 26/342; B33Y 10/00; B33Y 70/00; B33Y 80/00; B22F 2301/205; B23K 2103/14

(57) ABSTRACT

The present disclosure relates to an accelerator lead-out window and a preparation method thereof, wherein an overall structure of the accelerator lead-out window is integrally formed by adopting an additive manufacturing method; a window film is made of titanium alloy, and each component ratio is calculated by a weight percentage, wherein Al:4.5-7.5%, Mo:4.1-6.9%, V:4.1-6.9%, Nb:3.1-4.5%, Cr 1.5-3.5%, Ta:0.5-1.5%, and the remaining amount is titanium and other unavoidable elements. A window frame is made of aluminum alloy, and each component ratio is calculated by a weight percentage, wherein Zn:5.1-6.9%, Mg:2.1-3.9%, Cu:1.2-3.9%, Cr:0.18-0.28%, Fe≤0.30%, Si≤0.15%, Ti≤0.15%, Mn≤0.10%, and the remaining amount is Al and other unavoidable elements.

### CROSS REFERENCE TO RELATED APPLICATIONS

This application claims the benefit of priority from Chinese Patent Application No. 202411498229.2 entitled “ACCELERATOR LEAD-OUT WINDOW AND PREPARATION METHOD THEREOF” and filed on Oct. 25, 2024, the content of which is hereby incorporated by reference in its entire by reference.

### BACKGROUND

### 1. Technical Field

The present disclosure generally relates to the field of accelerators and additive manufacturing technologies, and especially relates to an accelerator lead-out window and a preparation method thereof.

### 2. Description of Related Art

An ion beam that is generated and accelerated from the accelerator is carried out in a high vacuum environment, a window film plays a role of beam extraction in radiation therapy ion accelerators, while separating the vacuum from the atmosphere, it is necessary to ensure that the beam can “freely” pass through the window film material to irradiate a target object in the atmosphere. Titanium alloy is used as a beam window material in particle accelerator devices worldwide due to its high specific strength, high-temperature mechanical properties, excellent oxidation resistance, and a relatively low modulus and a thermal expansion coefficient, resulting in high thermal shock resistance. A window frame is usually made of stainless steel and copper materials for providing structural support and installation for the titanium film, and even including cooling for the titanium film. A titanium window that is commonly used, is generally prepared using a soft soldering process or a hard soldering process, that is, adopting tin-lead solder, silver copper brazing filler metal to weld titanium foil, with an oxygen free copper window frame, to form a vacuum sealed structure. It is difficult to connect a lead-out device that has the window frame made of stainless steel through a conventional welding technology. Instead, a conventional extrusion process and a stamping process are used to perform tight extrusion for obtaining vacuum sealing thereof. However, such mechanical sealing effect is poor, and a rubber ring sealing mode has a high leakage rate and insufficient long-term reliability.

In the related art, when pure titanium with a thickness of 35 μm is used as a material of the window film, high-temperature performance of the window film is insufficient when a working temperature is selected within 350° C. When commercially pure titanium TA2 foil with a thickness of 0.15 mm is used as the material of the window film, and oxygen free copper TUI is used as the window frame, a layer of titanium foil is brazed at a circular arc opening of the semi-circular window frame through a brazing process. This method is prone to defects in a welding area and poses a risk of vacuum leakage. A Chinese patent CN210937744U discloses a titanium window, which is first connected by brazing an alloy ring with a low expansion coefficient, and a titanium foil, and then the other side of the alloy ring with the low expansion coefficient is welded and fixed to a sealing flange of the titanium window by an argon arc welding mode. Another Chinese patent CN115942588A discloses an electron beam extraction device and an electron accelerator thereof that a frame of the electron beam extraction device and a titanium film are welded together to form an integral sealing structure by adopting the solder and welding transition components. The manufacturing process of the brazing mode or the welding mode mentioned above has problems such as a complex structure, a poor sealing performance of the lead-out window, and cracks that are prone to occur in the welded area.

### SUMMARY

The technical problems to be solved: in view of the shortcomings of the related art, the present disclosure provides an accelerator lead-out window and a preparation method thereof that the window film material configured by the present disclosure has significantly improved high-temperature mechanical properties compared to conventional materials, and adopts an additive manufacturing method to integrate the accelerator lead-out window structure, which can reduce vacuum leakage and have good sealing performance, and after performing heat-treatment, local stress is eliminated, thereby significantly reducing a risk of cracks and fissures that are prone to occur in conventional welding processes.

In order to solve the above objectives, the present disclosure provides the following technical solution.

An accelerator lead-out window includes a window film and a window frame, wherein the window film is made of titanium alloy, and each component ratio is calculated by a weight percentage, wherein Al:4.5-7.5%, Mo:4.1-6.9%, V:4.1-6.9%, Nb:3.1-4.5%, Cr 1.5-3.5%, Ta:0.5-1.5%, and the remaining amount is titanium and other unavoidable elements; and wherein the window frame is made of aluminum alloy, and each component ratio is calculated by a weight percentage, wherein Zn:5.1-6.9%, Mg:2.1-3.9%, Cu:1.2-3.9%, Cr 0.18-0.28%, Fe≤0.30%, Si≤0.15%, Ti≤0.15%, Mn≤0.10%, and the remaining amount is Al and other unavoidable elements.

A preparation method of an accelerator lead-out window by using an additive manufacturing method, includes the following steps:
step 1, pre-processing before printing: mixing titanium alloy and grinding into titanium alloy powder, and drying the titanium alloy powder, mixing aluminum alloy and grinding into aluminum alloy powder, and drying the aluminum alloy powder; and then laying the titanium alloy powder, the aluminum alloy powder, and mixed powder of the titanium alloy powder and the aluminum alloy powder on a substrate, respectively; and wherein
the substrate is provided with a window film area, a window frame area, and a transition area that the window film borders on the window frame; and wherein
the titanium alloy powder is laid on the window film area, the aluminum alloy powder is laid on the window frame area, and the mixed powder of the titanium alloy powder and the aluminum alloy powder is laid on the transition area;
step 2, performing regional printing by using a laser selective melting technology: when the powder laid on the step 1 is printed, a single melt scanning molding is used, with a protective atmosphere of argon gas and an oxygen content no more than 50 ppm; and wherein
for the window film area, process parameters that are set on a laser equipment are: a laser power of 40-60W, a spot diameter of 20-22 μm, a powder layer thickness of 8-12 μm, a scanning speed of 400-800 mm/s, a laser energy density of 60-120J/mm³; and wherein
for the window frame area, the process parameters that are set on the laser equipment are: the laser power of 300-350W, the spot diameter of 55-65 μm, the powder layer thickness of 40-50 μm, the scanning speed of 900-1500 mm/s, the laser energy density of 70-130J/mm³; and wherein
for the transition area, the process parameters that are set on the laser equipment are: the laser power of 200-280W, the spot diameter of 50-60 μm, the powder layer thickness of 30-50 μm, the scanning speed of 800-1200 mm/s, and the laser energy density of 65-125J/mm³; and
step 3, after the printing is completed, sequentially cleaning, performing heat-treatment, smoothing surfaces and perform surface oxidation treatment on a sample that is prepared in the step 2.

Wherein a drying condition for drying the titanium alloy powder that is prepared in the step 1 is: drying at a temperature of 80-120° C. for 1-5 hours, and a drying condition for drying the aluminum alloy powder is: drying at a temperature of 60-100° C. for 1-5 hours; and preheating the substrate to a temperature of 80-210° C.

Wherein the window film area uses the titanium alloy powder with a particle size of 5-18 μm, the window frame area uses the aluminum alloy powder with a particle size of 15-53 μm, and the transition area mixes the titanium alloy powder and the aluminum alloy powder in a ratio of 1:1.

Wherein the window film area has an apparent density greater than or equal to 1.20 g/cm³, a tap density greater than or equal to 1.70 g/cm³, a flowability less than or equal to 130s/50 g, and a hollow powder content less than or equal to 4%; and wherein the window frame area has an apparent density greater than or equal to 1.30 g/cm³, a compacted density greater than or equal to 1.50 g/cm³, a flowability less than or equal to 120s/50 g, and a hollow powder rate less than or equal to 4%; the transition area has an apparent density greater than or equal to 1.10 g/cm³, a tap density greater than or equal to 1.60 g/cm³, a flowability less than or equal to 120s/50 g, and a hollow powder content less than or equal to 4%.

Wherein the step of cleaning the sample is as follows: performing ultrasonic cleaning on the sample by adopting acetone, anhydrous ethanol, and distilled water in turn for 10-15 minutes, and drying the sample that is cleaned by a hair drier.

Wherein the step of performing heat-treatment is as follows: performing laser heat-treatment on the sample according to different areas: a heating temperature of the window film area is 500-620° C. and a holding time is 0.5-2 hours, the heating temperature of the window frame area is 100-200° C. and the holding time is 0.5-2 hours, and the heating temperature of the transition area is 350-500° C. and the holding time is 0.5-2 hours.

Wherein the step of smoothing surfaces is as follows: processing the surfaces of the window film by adopting a steam smoothing technology, firstly preparing a nitric acid solution and placing the sample and the nitric acid solution in a sealed treatment chamber, and then, the nitric acid solution is heated to a specific temperature so that the resulting steam reacts with the surface material of the sample to smooth the surface.

Wherein the step of performing surface oxidation treatment is as follows: preparing a coating on the surface of the window film by using a micro arc oxidation technology.

Wherein process conditions of the micro arc oxidation are: a voltage of 30-70V, a frequency of 100-500 Hz, a duty cycle of 10-60%, a micro arc oxidation electrolyte temperature of 30-50° C., and a micro arc oxidation time of 5-20 min.

The present disclosure provides advantages as below.

Firstly, the material of the accelerator lead-out window film proposed by the present disclosure has specific strength (tensile strength/material density) of about 230N·m/kg, high heat resistance, and high strength and surface hardness, compared with conventional materials, which can significantly improve high-temperature mechanical properties and have a long service life, reduce a replacement frequency and improve an overall equipment performance.

Secondly, the present disclosure adopts the additive manufacturing method to integrally form the overall structure of the accelerator lead-out window, thereby reducing vacuum leakage. After performing special heat treatment, local stress is eliminated, thereby significantly reducing a risk of cracks and fissures that are prone to occur in conventional welding processes.

Thirdly, the present disclosure adopts the micro arc oxidation technology to form a surface coating on the surface of the window film, thereby improving the high-temperature oxidation resistance of the substrate while significantly increasing a surface hardness of the window film; furthermore, the laser is used to perform heat-treatment on the window film in different regions to achieve solid solution strengthening and uniform annealing, and improve the surface hardness, thereby enhancing impact resistance thereof.

### BRIEF DESCRIPTION OF THE DRAWINGS

FIG. 1 is a metallographic structure diagram of alloy in accordance with a first embodiment of the present disclosure.

FIG. 2 is a metallographic structure diagram of alloy in accordance with a second embodiment of the present disclosure.

FIG. 3 is a metallographic structure diagram of alloy in accordance with a third embodiment of the present disclosure.

### DETAILED DESCRIPTION

The following provides a further detailed explanation of the present disclosure in conjunction with the accompanying drawings and embodiments, specific embodiments of the present disclosure are further described in detail below, but the present disclosure is not limited to these embodiments. Any improvement or replacement in the basic spirit of the embodiments are within the protection scope of the present disclosure.

An accelerator lead-out window of the present disclosure includes a window film and a window frame. The window film is made of titanium alloy, and each component ratio is calculated by a weight percentage, wherein Al:4.5-7.5%, Mo:4.1-6.9%, V:4.1-6.9%, Nb:3.1-4.5%, Cr 1.5-3.5%, Ta:0.5-1.5%, and the remaining amount is titanium and other unavoidable elements. The window frame is made of aluminum alloy, and each component ratio is calculated by a weight percentage, wherein Zn:5.1-6.9%, Mg:2.1-3.9%, Cu:1.2-3.9%, Cr 0.18-0.28%, Fe≤0.30%, Si≤0.15%, Ti≤0.15%, Mn≤0.10%, and the remaining amount is Al and other unavoidable elements.

A preparation method of an accelerator lead-out window according to an embodiment of the present disclosure is provided that an additive manufacturing method is used, wherein the preparation method includes the following steps.

Step 1, pre-processing before printing: mixing titanium alloy and grinding into titanium alloy powder, and drying the titanium alloy powder, mixing aluminum alloy and grinding into aluminum alloy powder, and drying the aluminum alloy powder; dividing a substrate into a window film area, a window frame area, and a transition area that the window film borders on the window frame, and then the titanium alloy powder is laid on the window film area, the aluminum alloy powder is laid on the window frame area, and the mixed powder of the titanium alloy powder and the aluminum alloy powder is laid on the transition area. A drying condition for drying the titanium alloy powder is: drying at a temperature of 80-120° C. for 1-5 hours, and a drying condition for drying the aluminum alloy powder is: drying at a temperature of 60-100° C. for 1-5 hours; and preheating the substrate to a temperature of 80-210° C. In an embodiment of the present disclosure, the substrate is made of stainless steel.

The window film area uses the titanium alloy powder with a particle size of 5-18 μm, with an apparent density greater than or equal to 1.20 g/cm³, a tap density greater than or equal to 1.70 g/cm³, a flowability less than or equal to 130s/50 g, and a hollow powder content less than or equal to 4%. The window frame area uses the aluminum alloy powder with a particle size of 15-53 μm, with an apparent density greater than or equal to 1.30 g/cm³, a compacted density greater than or equal to 1.50 g/cm³, a flowability less than or equal to 120s/50 g, and a hollow powder rate less than or equal to 4%. The transition area mixes the titanium alloy powder and the aluminum alloy powder in a ratio of 1:1, and the transition area has an apparent density greater than or equal to 1.10 g/cm³, a tap density greater than or equal to 1.60 g/cm³, a flowability less than or equal to 120s/50 g, and a hollow powder content less than or equal to 4%.

Step 2, performing regional printing by using a laser selective melting technology: when the powder laid on the step 1 is printed, a single melt scanning molding is used, with a protective atmosphere of argon gas and an oxygen content no more than 50 ppm.

For the window film area, process parameters that are set on a laser equipment are: a laser power of 40-60W, a spot diameter of 20-22 μm, a powder layer thickness of 8-12 μm, a scanning speed of 400-800 mm/s, a laser energy density of 60-120J/mm³.

For the window frame area, the process parameters that are set on the laser equipment are: the laser power of 300-350W, the spot diameter of 55-65 μm, the powder layer thickness of 40-50 μm, the scanning speed of 900-1500 mm/s, the laser energy density of 70-130J/mm³.

For the transition area, the process parameters that are set on the laser equipment are: the laser power of 200-280W, the spot diameter of 50-60 μm, the powder layer thickness of 30-50 μm, the scanning speed of 800-1200 mm/s, and the laser energy density of 65-125J/mm³.

Step 3, after the printing is completed, performing ultrasonic cleaning on the sample that is prepared in the step 2 by adopting acetone, anhydrous ethanol, and distilled water in turn for 10-15 minutes, and drying the sample that is cleaned by a hair drier, wherein a pureness of the acetone is greater than or equal to 99%. And then, performing laser heat-treatment on the sample according to different areas: a heating temperature of the window film area is 500-620° C. and a holding time is 0.5-2 hours, the heating temperature of the window frame area is 100-200° C. and the holding time is 0.5-2 hours, and the heating temperature of the transition area is 350-500° C. and the holding time is 0.5-2 hours. Furthermore, processing surfaces of the window film by adopting a steam smoothing technology, firstly preparing a nitric acid solution, wherein taking nitric acid with a concentration of 68%-72% that is commonly used in a laboratory, and preparing the nitric acid solution according to a volume ratio of HNO₃:H₂O that is 3:7. Placing the sample and the nitric acid solution in a sealed treatment chamber, and then, the nitric acid solution is heated to a temperature of 30-50° C. so that the resulting steam reacts with the surface material of the sample to smooth the surface. Finally, under conditions of a voltage of 30-70V, a frequency of 100-500 Hz, a duty cycle of 10-60%, a micro arc oxidation electrolyte temperature of 30-50° C., and a micro arc oxidation time of 5-20 min, a coating is prepared on the surface of the window film by using a micro arc oxidation technology. In an embodiment of the present disclosure, the micro arc oxidation electrolyte is prepared by mixing 21.5 g/L Ca (CH₃COO)₂·H₂O, 9.3 g/L NasP₃O₁₀, 7.5 g/L Na₂SiO₃·9H₂O, 6.1 g/L NaOH, and deionized water, wherein the deionized water is taken as the solvent. A formed thickness of the window film product that is obtained is 30-50 μm, with a surface roughness less than or equal to 2 μm, and a formed thickness of the window frame product is 2-5 mm, with a surface roughness less than or equal to 5 μm.

The present disclosure adopts the additive manufacturing method to integrally form the overall structure of the accelerator lead-out window, thereby reducing vacuum leakage. After performing special heat treatment, local stress is eliminated, thereby significantly reducing a risk of cracks and fissures that are prone to occur in conventional welding processes.

The present disclosure adopts the micro arc oxidation technology to form a surface coating on the surface of the window film, thereby improving the high-temperature oxidation resistance of the substrate while significantly increasing a surface hardness of the window film; furthermore, the laser is used to perform heat-treatment on the window film in different regions to achieve solid solution strengthening and uniform annealing, and improve the surface hardness, thereby enhancing impact resistance thereof.

### A First Embodiment

The window film of an accelerator lead-out window is made of titanium alloy, and each component ratio is calculated by a weight percentage, wherein Al:4.5%, Mo:4.1%, V:4.1%, Nb:3.1%, Cr 1.5%, Ta:0.5%, and the remaining amount is titanium and other unavoidable elements. The window frame is made of aluminum alloy, and each component ratio is calculated by a weight percentage, wherein Zn:5.1%, Mg:2.1%, Cu:1.2%, Cr 0.18%, Fe:0.25%, Si:0.15%, Ti:0.11%, Mn:0.08%, and the remaining amount is Al and other unavoidable elements.

The preparation method of the accelerator lead-out window is provided that an additive manufacturing method is used, wherein the preparation method includes the following steps.

Step 1, pre-processing before printing: mixing titanium alloy and grinding into titanium alloy powder, and drying the titanium alloy powder, mixing aluminum alloy and grinding into aluminum alloy powder, and drying the aluminum alloy powder; dividing a substrate into a window film area, a window frame area, and a transition area that the window film borders on the window frame, and then the titanium alloy powder is laid on the window film area, the aluminum alloy powder is laid on the window frame area, and the mixed powder of the titanium alloy powder and the aluminum alloy powder is laid on the transition area. A drying condition for drying the titanium alloy powder is: drying at a temperature of 80° C. for 5 hours, and a drying condition for drying the aluminum alloy powder is: drying at a temperature of 60° C. for 5 hours; and preheating the substrate to a temperature of 120° C. The material of the window film uses the titanium alloy powder with a particle size of 5 μm, with an apparent density of 1.30 g/cm³, a tap density of 1.80 g/cm³, a flowability of 125s/50 g, and a hollow powder content of 3%. The material of the window frame uses the aluminum alloy powder with a particle size of 15 μm, with an apparent density of 1.30 g/cm³, a compacted density of 1.55 g/cm³, a flowability of 115s/50 g, and a hollow powder rate of 2%. The transition areas of the window film and the window frame mix the titanium alloy powder and the aluminum alloy powder in a ratio of 1:1, with an apparent density of 1.15 g/cm³, a tap density of 1.63 g/cm³, a flowability of 110s/50 g, and a hollow powder content of 2%.

Step 2, performing regional printing by using a laser selective melting technology: when the powder laid on the step 1 is printed, a single melt scanning molding is used, with a protective atmosphere of argon gas and an oxygen content no more than 50 ppm.

For the window film area, process parameters that are set on a laser equipment are: a laser power of 40W, a spot diameter of 20 μm, a powder layer thickness of 8 μm, a scanning speed of 400 mm/s, a laser energy density of 60 J/mm³.

For the window frame area, the process parameters that are set on the laser equipment are: the laser power of 300W, the spot diameter of 55 μm, the powder layer thickness of 40 μm, the scanning speed of 900 mm/s, the laser energy density of 70 J/mm³.

For the transition area, the process parameters that are set on the laser equipment are: the laser power of 200W, the spot diameter of 50 μm, the powder layer thickness of 30 μm, the scanning speed of 800 mm/s, and the laser energy density of 65J/mm³.

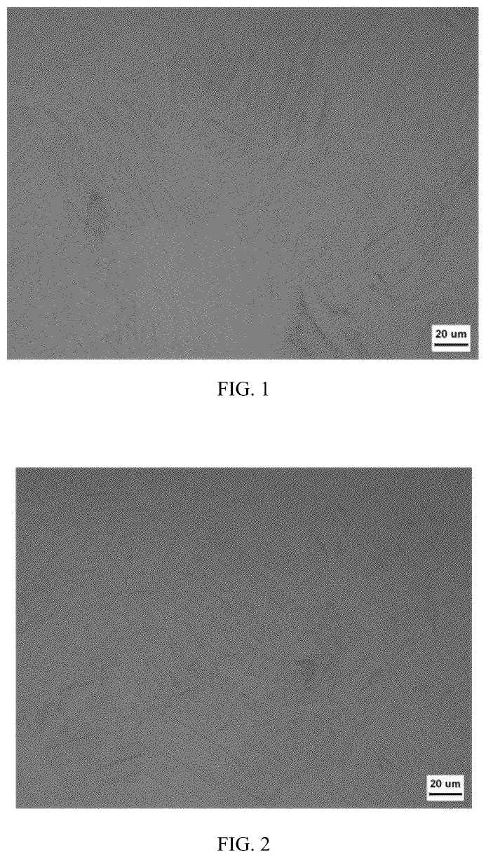

Step 3, after the printing is completed, performing ultrasonic cleaning on the sample that is prepared in the step 2 by adopting acetone, anhydrous ethanol, and distilled water in turn for 10 minutes, and drying the sample that is cleaned by a hair drier. And then, performing laser heat-treatment on the sample according to different areas: a heating temperature of the window film area is 500° C. and a holding time is 0.5 hour, the heating temperature of the window frame area is 100° C. and the holding time is 0.5 hour, and the heating temperature of the transition area is 350° C. and the holding time is 0.5 hour. Furthermore, processing surfaces of the window film by adopting a steam smoothing technology, firstly preparing a nitric acid solution according to a volume ratio of HNO₃:H₂O that is 3:7. Placing the sample and the nitric acid solution in the sealed treatment chamber, and then, the nitric acid solution is heated to a temperature of 30° C. so that the resulting steam reacts with the surface material of the sample to smooth the surface. Finally, under conditions of a voltage of 30V, a frequency of 100 Hz, a duty cycle of 10%, a micro arc oxidation electrolyte temperature of 30° C., and a micro arc oxidation time of 5 min, a coating is prepared on the surface of the window film by using a micro arc oxidation technology, to effectively improve the high-temperature oxidation resistance of the substrate. A formed thickness of the window film product that is obtained is 30 μm, with a surface roughness of 2 μm, and a formed thickness of the window frame product is 2 mm, with a surface roughness of 5 μm. The metallographic structure diagram of the alloy is shown in FIG. 1.

### A Second Embodiment

The window film of the accelerator lead-out window is made of titanium alloy, and each component ratio is calculated by a weight percentage, wherein Al:5.5%, Mo:5.2%, V:5.1%, Nb:4.1%, Cr 2.5%, Ta:1.0%, and the remaining amount is titanium and other unavoidable elements. The window frame is made of aluminum alloy, and each component ratio is calculated by a weight percentage, wherein Zn:6.1%, Mg:2.9%, Cu:3.5%, Cr 0.22%, Fe:0.20%, Si:0.10%, Ti:0.09%, Mn:0.05%, and the remaining amount is Al and other unavoidable elements.

The preparation method of the accelerator lead-out window is provided that an additive manufacturing method is used, wherein the preparation method includes the following steps.

Step 1, pre-processing before printing: mixing titanium alloy and grinding into titanium alloy powder, and drying the titanium alloy powder, mixing aluminum alloy and grinding into aluminum alloy powder, and drying the aluminum alloy powder; dividing a substrate into a window film area, a window frame area, and a transition area that the window film borders on the window frame, and then the titanium alloy powder is laid on the window film area, the aluminum alloy powder is laid on the window frame area, and the mixed powder of the titanium alloy powder and the aluminum alloy powder is laid on the transition area. A drying condition for drying the titanium alloy powder is: drying at a temperature of 100° C. for 3 hours, and a drying condition for drying the aluminum alloy powder is: drying at a temperature of 80° C. for 2 hours; and preheating the substrate to a temperature of 80° C. The material of the window film uses the titanium alloy powder with a particle size of 10 μm, with an apparent density of 1.35 g/cm³, a tap density of 1.83 g/cm³, a flowability of 120s/50 g, and a hollow powder content of 2%. The material of the window frame uses the aluminum alloy powder with a particle size of 35 μm, with an apparent density of 1.35 g/cm³, a compacted density of 1.65 g/cm³, a flowability of 110s/50 g, and a hollow powder rate of 3%. The transition areas of the window film and the window frame mix the titanium alloy powder and the aluminum alloy powder in a ratio of 1:1, with an apparent density of 1.25 g/cm³, a tap density of 1.68 g/cm³, a flowability of 100s/50 g, and a hollow powder content of 3%.

Step 2, performing regional printing by using a laser selective melting technology: when the powder laid on the step 1 is printed, a single melt scanning molding is used, with a protective atmosphere of argon gas and an oxygen content no more than 50 ppm.

For the window film area, process parameters that are set on a laser equipment are: a laser power of 50W, a spot diameter of 21 μm, a powder layer thickness of 10 μm, a scanning speed of 600 mm/s, a laser energy density of 80J/mm³.

For the window frame area, the process parameters that are set on the laser equipment are: the laser power of 320W, the spot diameter of 60 μm, the powder layer thickness of 45 μm, the scanning speed of 1200 mm/s, the laser energy density of 100J/mm³.

For the transition area, the process parameters that are set on the laser equipment are: the laser power of 230W, the spot diameter of 55 μm, the powder layer thickness of 40 μm, the scanning speed of 1000 mm/s, and the laser energy density of 85J/mm³.

Step 3, after the printing is completed, performing ultrasonic cleaning on the sample that is prepared in the step 2 by adopting acetone, anhydrous ethanol, and distilled water in turn for 12 minutes, and drying the sample that is cleaned by a hair drier. And then, performing laser heat-treatment on the sample according to different areas: a heating temperature of the window film area is 550° C. and a holding time is 2 hours, the heating temperature of the window frame area is 120° C. and the holding time is 2 hours, and the heating temperature of the transition area is 400° C. and the holding time is 2 hours. Furthermore, processing surfaces of the window film by adopting a steam smoothing technology, firstly preparing a nitric acid solution according to a volume ratio of HNO₃:H₂O that is 3:7. Placing the sample and the nitric acid solution in the sealed treatment chamber, and then, the nitric acid solution is heated to a temperature of 40° C. so that the resulting steam reacts with the surface material of the sample to smooth the surface. Finally, under conditions of a voltage of 50V, a frequency of 300 Hz, a duty cycle of 30%, a micro arc oxidation electrolyte temperature of 40° C., and a micro arc oxidation time of 10 min, a coating is prepared on the surface of the window film by using a micro arc oxidation technology, to effectively improve the high-temperature oxidation resistance of the substrate. A formed thickness of the window film product that is obtained is 40 μm, with a surface roughness less than or equal to 2 μm, and a formed thickness of the window frame product is 3 mm, with a surface roughness less than or equal to 5 μm. The metallographic structure diagram of the alloy is shown in FIG. 2.

### A Third Embodiment

The window film of the accelerator lead-out window is made of titanium alloy, and each component ratio is calculated by a weight percentage, wherein Al:7.5%, Mo:6.9%, V:6.9%, Nb:4.5%, Cr 3.5%, Ta:1.5%, and the remaining amount is titanium and other unavoidable elements. The window frame is made of aluminum alloy, and each component ratio is calculated by a weight percentage, wherein Zn:6.9%, Mg:3.9%, Cu:3.9%, Cr 0.28%, Fe:0.30%, Si:0.15%, Ti:0.15%, Mn:0.10%, and the remaining amount is Al and other unavoidable elements.

The preparation method of the accelerator lead-out window is provided that an additive manufacturing method is used, wherein the preparation method includes the following steps.

Step 1, pre-processing before printing: mixing titanium alloy and grinding into titanium alloy powder, and drying the titanium alloy powder, mixing aluminum alloy and grinding into aluminum alloy powder, and drying the aluminum alloy powder; dividing a substrate into a window film area, a window frame area, and a transition area that the window film borders on the window frame, and then the titanium alloy powder is laid on the window film area, the aluminum alloy powder is laid on the window frame area, and the mixed powder of the titanium alloy powder and the aluminum alloy powder is laid on the transition area. A drying condition for drying the titanium alloy powder is: drying at a temperature of 120° C. for 1 hour, and a drying condition for drying the aluminum alloy powder is: drying at a temperature of 100° C. for 1 hour; and preheating the substrate to a temperature of 210° C. The material of the window film uses the titanium alloy powder with a particle size of 18 μm, with an apparent density of 1.20 g/cm³, a tap density of 1.70 g/cm³, a flowability of 130s/50 g, and a hollow powder content of 4%. The material of the window frame uses the aluminum alloy powder with a particle size of 53 μm, with an apparent density of 1.40 g/cm³, a compacted density of 1.5 g/cm³, a flowability of 120s/50 g, and a hollow powder rate of 4%. The transition areas of the window film and the window frame mix the titanium alloy powder and the aluminum alloy powder in a ratio of 1:1, with an apparent density of 1.10 g/cm³, a tap density of 1.60 g/cm³, a flowability of 120s/50 g, and a hollow powder content of 4%.

Step 2, performing regional printing by using a laser selective melting technology: when the powder laid on the step 1 is printed, a single melt scanning molding is used, with a protective atmosphere of argon gas and an oxygen content no more than 50 ppm.

For the window film area, process parameters that are set on a laser equipment are: a laser power of 60W, a spot diameter of 22 μm, a powder layer thickness of 12 μm, a scanning speed of 800 mm/s, a laser energy density of 120J/mm³.

For the window frame area, the process parameters that are set on the laser equipment are: the laser power of 350W, the spot diameter of 65 μm, the powder layer thickness of 50 μm, the scanning speed of 1500 mm/s, the laser energy density of 130J/mm³.

For the transition area, the process parameters that are set on the laser equipment are: the laser power of 280W, the spot diameter of 60 μm, the powder layer thickness of 50 μm, the scanning speed of 1200 mm/s, and the laser energy density of 125J/mm³.

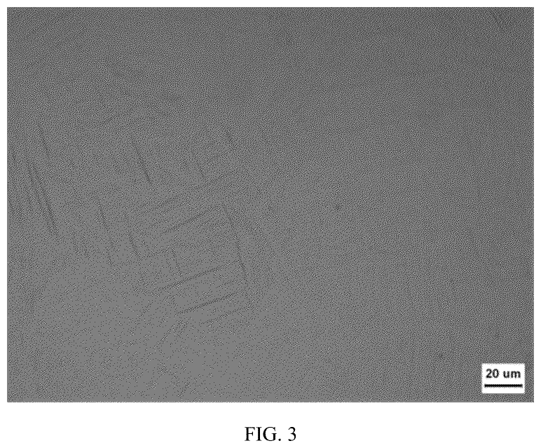

Step 3, after the printing is completed, performing ultrasonic cleaning on the sample that is prepared in the step 2 by adopting acetone, anhydrous ethanol, and distilled water in turn for 15 minutes, and drying the sample that is cleaned by a hair drier. And then, performing laser heat-treatment on the sample according to different areas: a heating temperature of the window film area is 620° C. and a holding time is 1 hour, the heating temperature of the window frame area is 200° C. and the holding time is 1 hour, and the heating temperature of the transition area is 500° C. and the holding time is 1 hour. Furthermore, processing surfaces of the window film by adopting a steam smoothing technology, firstly preparing a nitric acid solution according to a volume ratio of HNO₃:H₂O that is 3:7. Placing the sample and the nitric acid solution in the sealed treatment chamber, and then, the nitric acid solution is heated to a temperature of 50° C. so that the resulting steam reacts with the surface material of the sample to smooth the surface. Finally, under conditions of a voltage of 70V, a frequency of 500 Hz, a duty cycle of 60%, a micro arc oxidation electrolyte temperature of 50° C., and a micro arc oxidation time of 20 min, a coating is prepared on the surface of the window film by using a micro arc oxidation technology, to effectively improve the high-temperature oxidation resistance of the substrate. A formed thickness of the window film product that is obtained is 50 μm, with a surface roughness less than or equal to 2 μm, and a formed thickness of the window frame product is 5 mm, with a surface roughness less than or equal to 5 μm. The metallographic structure diagram of the alloy is shown in FIG. 3.

TABLE 1
Performance comparison of materials of the lead-out window film and the conventional
window film in the first to third embodiments of the present disclosure

| | Material | Specific | Yield | Tensile | Hardness | Usage |
|---|---|---|---|---|---|---|
| | density/ | strength/ | strength/ | strength/ | HV0.5/10/ | temperature/ |
| Material | g · cm⁻³ | N · m · kg⁻¹ | MPa | MPa | kgf · mm⁻² | ° C. |
| Titanium | 4.5 | 51.1-102.2 | 140-250 | 230-460 | 67-143 | 100 |
| TC4 | 4.5 | 191.3 | 768 | 861 | 294 | 200 |
| TC4 ELI | 4.5 | 198.0 | 792 | 891 | 305 | 200 |
| First | 4.6 | 229.6 | 925 | 1056 | 352 | 350 |
| embodiment | | | | | | |
| Second | 4.7 | 226.4 | 937 | 1064 | 359 | 350 |
| embodiment | | | | | | |
| Third | 4.6 | 233.3 | 936 | 1073 | 361 | 350 |
| embodiment | | | | | | |

According to Table 1, it can be seen that the material of the accelerator lead-out window film in accordance with the first embodiment to the third embodiment of the present disclosure has a specific strength that is obtained by dividing the tensile strength by the material density, which is about 230N·m/kg. HV0.5/10 is a Vickers hardness that is maintained for 10 seconds under a compression load of 4.9N (500 gf). The window film of the present disclosure can significantly improve high-temperature mechanical properties compared to conventional materials, with a high heat resistance, a high tensile strength and a surface hardness, have a long service life, reduce replacement frequencies, and improved overall equipment performance thereof. Data in Table 1 that are not from embodiments of the present disclosure are all from conventional technologies.

What is claimed is:

1. An accelerator lead-out window comprising a window film and a window frame, wherein the window film is made of titanium alloy, and each component ratio is calculated by a weight percentage, wherein Al:4.5-7.5%, Mo:4.1-6.9%, V: 4.1-6.9%, Nb:3.1-4.5%, Cr 1.5-3.5%, Ta:0.5-1.5%, and the remaining amount is titanium and other unavoidable elements; and wherein the window frame is made of aluminum alloy, and each component ratio is calculated by a weight percentage, wherein Zn:5.1-6.9%, Mg:2.1-3.9%, Cu:1.2-3.9%, Cr 0.18-0.28%, Fe≤0.30%, Si≤0.15%, Ti≤0.15%, Mn≤0.10%, and the remaining amount is Al and other unavoidable elements; and wherein the window film and the window frame are integrated structures that are printed through an additive manufacturing mode, wherein the printing method comprises the following steps:
step 1, pre-processing before printing: mixing titanium alloy and grinding into titanium alloy powder, and drying the titanium alloy powder, mixing aluminum alloy and grinding into aluminum alloy powder, and drying the aluminum alloy powder; and then laying the titanium alloy powder, the aluminum alloy powder, and mixed powder of the titanium alloy powder and the aluminum alloy powder on a substrate, respectively; and wherein the substrate is provided with a window film area, a window frame area, and a transition area that the window film borders on the window frame; and wherein the titanium alloy powder is laid on the window film area, the aluminum alloy powder is laid on the window frame area, and the mixed powder of the titanium alloy powder and the aluminum alloy powder is laid on the transition area;
step 2, performing regional printing by using a laser selective melting technology: when the powder laid on the step 1 is printed, a single melt scanning molding is used, with a protective atmosphere of argon gas and an oxygen content no more than 50 ppm; and wherein
for the window film area, process parameters that are set on a laser equipment are: a laser power of 40-60W, a spot diameter of 20-22 μm, a powder layer thickness of 8-12 μm, a scanning speed of 400-800 mm/s, a laser energy density of 60-120J/mm³; and wherein
for the window frame area, the process parameters that are set on the laser equipment are: the laser power of 300-350W, the spot diameter of 55-65 μm, the powder layer thickness of 40-50 μm, the scanning speed of 900-1500 mm/s, the laser energy density of 70-130J/mm³; and wherein
for the transition area, the process parameters that are set on the laser equipment are: the laser power of 200-280W, the spot diameter of 50-60 μm, the powder layer thickness of 30-50 μm, the scanning speed of 800-1200 mm/s, and the laser energy density of 65-125J/mm³; and
step 3, after the printing is completed, sequentially cleaning, performing heat-treatment, smoothing surfaces and perform surface oxidation treatment on a sample that is prepared in the step 2.

2. The accelerator lead-out window as claimed in claim 1, wherein a drying condition for drying the titanium alloy powder that is prepared in the step 1 is: drying at a temperature of 80-120° C. for 1-5 hours, and a drying condition for drying the aluminum alloy powder is: drying at a temperature of 60-100° C. for 1-5 hours; and preheating the substrate to a temperature of 80-210° C.

3. The accelerator lead-out window as claimed in claim 1, wherein the window film area uses the titanium alloy powder with a particle size of 5-18 μm, the window frame area uses the aluminum alloy powder with a particle size of 15-53 μm, and the transition area mixes the titanium alloy powder and the aluminum alloy powder in a ratio of 1:1.

4. The accelerator lead-out window as claimed in claim 3, wherein the window film area has an apparent density greater than or equal to 1.20 g/cm³, a tap density greater than or equal to 1.70 g/cm³, a flowability less than or equal to 130s/50 g, and a hollow powder content less than or equal to 4%; and wherein the window frame area has an apparent density greater than or equal to 1.30 g/cm³, a compacted density greater than or equal to 1.50 g/cm³, a flowability less than or equal to 120s/50 g, and a hollow powder rate less than or equal to 4%; the transition area has an apparent density greater than or equal to 1.10 g/cm³, a tap density greater than or equal to 1.60 g/cm³, a flowability less than or equal to 120s/50 g, and a hollow powder content less than or equal to 4%.

5. The accelerator lead-out window as claimed in claim 1, wherein the step of cleaning the sample is as follows: performing ultrasonic cleaning on the sample by adopting acetone, anhydrous ethanol, and distilled water in turn for 10-15 minutes, and drying the sample that is cleaned by a hair drier.

6. The accelerator lead-out window as claimed in claim 1, wherein the step of performing heat-treatment is as follows: performing laser heat-treatment on the sample according to different areas: a heating temperature of the window film area is 500-620° C. and a holding time is 0.5-2 hours, the heating temperature of the window frame area is 100-200° C. and the holding time is 0.5-2 hours, and the heating temperature of the transition area is 350-500° C. and the holding time is 0.5-2 hours.

7. The accelerator lead-out window as claimed in claim 1, wherein the step of smoothing surfaces is as follows: processing the surfaces of the window film by adopting a steam smoothing technology, firstly preparing a nitric acid solution and placing the sample and the nitric acid solution in a sealed treatment chamber, and then, the nitric acid solution is heated to a specific temperature so that the resulting steam reacts with the surface material of the sample to smooth the surface.

8. The accelerator lead-out window as claimed in claim 1, wherein the step of performing surface oxidation treatment is as follows: preparing a coating on the surface of the window film by using a micro arc oxidation technology.

9. The accelerator lead-out window as claimed in claim 8, wherein process conditions of the micro arc oxidation are: a voltage of 30-70V, a frequency of 100-500 Hz, a duty cycle of 10-60%, a micro arc oxidation electrolyte temperature of 30-50° C., and a micro arc oxidation time of 5-20 min.
